(19) United States
(12) Patent Application Publication
(10) Pub. No.: US 2025/0357996 A1
(43) Pub. Date: Nov. 20, 2025

(54) OPTIMIZING THE USE OF UNMANNED AERIAL VEHICLES TO EXTEND WIRELESS NETWORK COVERAGE

(71) Applicant: AT&T Intellectual Property I, L.P., Atlanta, GA (US)

(72) Inventors: Dhruv Gupta, San Ramon, CA (US); Biplav Choudhury, Perth Amboy, NJ (US); Weihua Ye, Chicago, IL (US)

(21) Appl. No.: 18/667,658

(22) Filed: May 17, 2024

(51) Int. Cl. H04B 7/185; G06F 40/30; H04W 16/28

(52) U.S. Cl. CPC H04B 7/18504; H04W 16/28; G06F 40/30

(57) ABSTRACT

A method performed for optimizing the use of unmanned aerial vehicles to extend wireless network coverage includes receiving a command phrased in a natural language via an application programming interface that interacts with an operator of an unmanned aerial vehicle used to extend a coverage of a radio access network, extracting, from the command, an intent related to an operation of the unmanned aerial vehicle, determining a configuration of the unmanned aerial vehicle to achieve the intent, and sending, by the processing system, an instruction to the unmanned aerial vehicle to implement the configuration that is determined, wherein the instruction is formatted in an instruction set that is readable by the unmanned aerial vehicle.

The present disclosure relates generally to communications networks and relates more particularly to devices, non-transitory computer-readable media, and methods for optimizing the use of unmanned aerial vehicles to extend wireless network coverage.

### BACKGROUND

Many applications, including disaster recovery, private enterprise and industrial settings, and military applications, may utilize Fifth Generation (5G) unmanned aerial vehicle (UAV) based networks. In a 5G UAV-based network, a UAV may be used as a relay that amplifies the signals emitted by a cellular base station (e.g., a gNodeB), allowing those signals to travel further physical distances than would be possible without the amplification. Thus, the UAV may extend the physical coverage area of a cell served by the base station (and, thus, extend the physical coverage area of the 5G network).

### SUMMARY

In one example, the present disclosure describes a device, computer-readable medium, and method for optimizing the use of unmanned aerial vehicles to extend wireless network coverage. For instance, in one example, a method performed by a processing system including at least one processor includes receiving a command phrased in a natural language via an application programming interface that interacts with an operator of an unmanned aerial vehicle used to extend a coverage of a radio access network, extracting, from the command, an intent related to an operation of the unmanned aerial vehicle, determining a configuration of the unmanned aerial vehicle to achieve the intent, and sending, by the processing system, an instruction to the unmanned aerial vehicle to implement the configuration that is determined, wherein the instruction is formatted in an instruction set that is readable by the unmanned aerial vehicle.

In another example, a non-transitory computer-readable medium stores instructions which, when executed by a processor, cause the processor to perform operations. The operations include receiving a command phrased in a natural language via an application programming interface that interacts with an operator of an unmanned aerial vehicle used to extend a coverage of a radio access network, extracting, from the command, an intent related to an operation of the unmanned aerial vehicle, determining a configuration of the unmanned aerial vehicle to achieve the intent, and sending, by the processing system, an instruction to the unmanned aerial vehicle to implement the configuration that is determined, wherein the instruction is formatted in an instruction set that is readable by the unmanned aerial vehicle.

In another example, a device includes a processor and a computer-readable medium storing instructions which, when executed by the processor, cause the processor to perform operations. The operations include receiving a command phrased in a natural language via an application programming interface that interacts with an operator of an unmanned aerial vehicle used to extend a coverage of a radio access network, extracting, from the command, an intent related to an operation of the unmanned aerial vehicle, determining a configuration of the unmanned aerial vehicle to achieve the intent, and sending, by the processing system, an instruction to the unmanned aerial vehicle to implement the configuration that is determined, wherein the instruction is formatted in an instruction set that is readable by the unmanned aerial vehicle.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for optimizing the use of unmanned aerial vehicles to extend wireless network coverage, in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure optimizes the use of unmanned aerial vehicles to extend wireless network coverage. As discussed above, in a 5G UAV-based network, a UAV may be used as a relay that amplifies the signals emitted by a cellular base station (e.g., a gNodeB), allowing those signals to travel further physical distances than would be possible without the amplification. Thus, the UAV may extend the physical coverage area of a cell served by the base station (and, thus, extend the physical coverage area of the 5G network). It remains a challenge, however, to optimize 5G UAV-based networks for coverage, radio frequency (RF) interference, and energy/power. Part of the challenge is that the operator of the UAV(s) (e.g., an employee of a private enterprise, the military, or the like) may lack specialized training or expertise in UAV and network configuration.

Examples of the present disclosure provide a service management and organization (SMO) platform that can be deployed within a client premises to optimize operation of UAVs utilized by the client to extend the coverage of a wireless network. The SMO runs an application that allows an operator of a UAV to provide commands related to operation of the UAV in natural language (e.g., “conserve battery on relay” or “optimize beam configuration on base station”). The SMO then extracts an intent from the natural language command, determines an action that can be taken to fulfill the intent, and provides an instruction to the UAV in a machine-readable format to carry out the action.

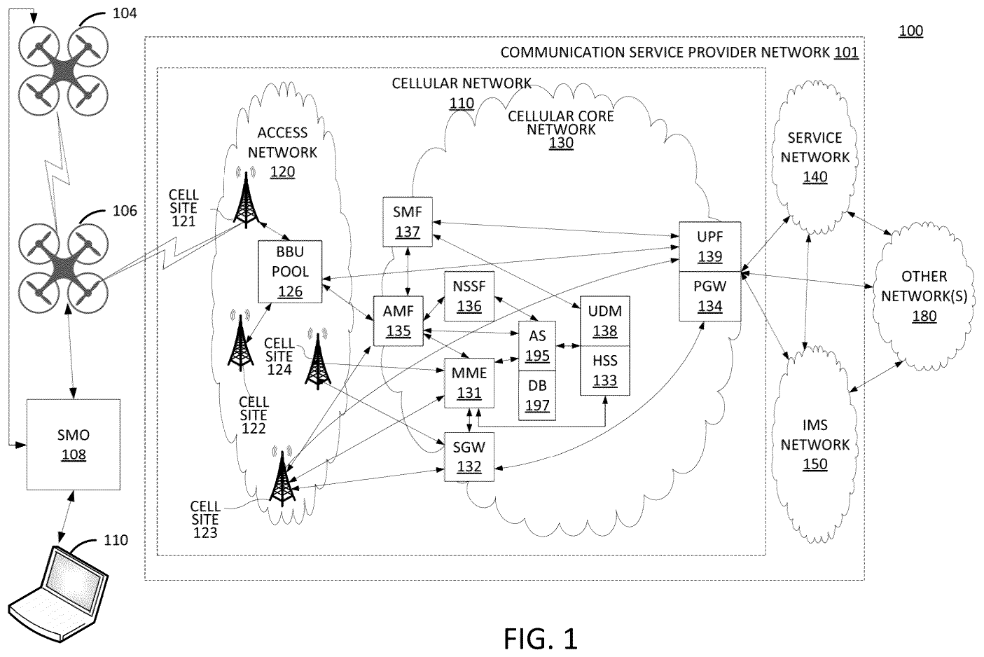

Although examples of the disclosure are discussed within the context of 5G open radio access networks (O-RANs), it will be appreciated that aspects of the disclosure may improve optimization of UAVs within other types of radio access networks as well. These and other aspects of the present disclosure are discussed in greater detail in connection with FIGS. 1-3, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a radio access network (RAN), such as a cloud RAN, a distributed RAN (D-RAN), a centralized RAN (C-RAN), a virtualized RAN (V-RAN), or an open RAN (O-RAN). As part of the migration of cellular networks towards 5G, an O-RAN may be coupled to an Evolved Packet Core (EPC) network until new cellular core networks are deployed in accordance with 5G specifications. In one example, access network 120 may include cell sites 121 and 122 and a baseband unit (BBU) pool 126. Radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although the RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU) to support an O-Ran infrastructure. In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

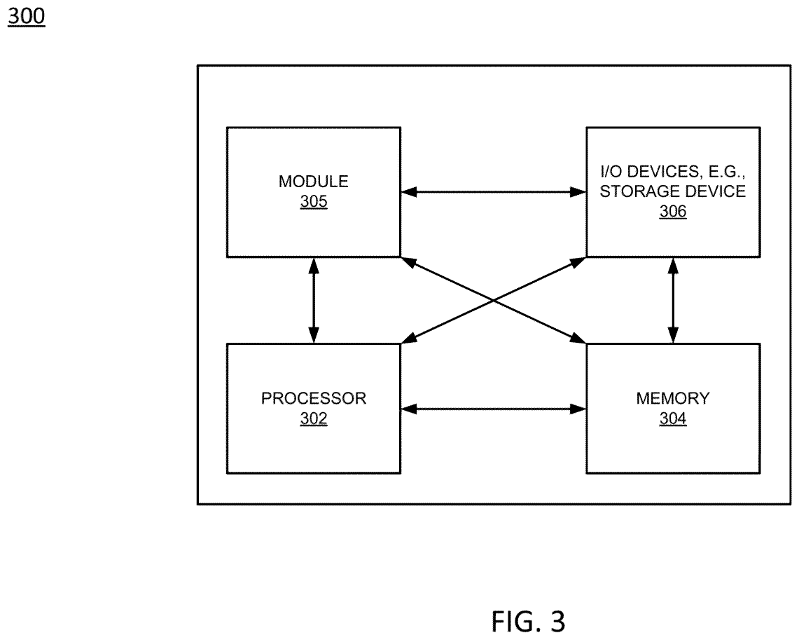

In accordance with the present disclosure, any one or more of cell sites 121-123 may be deployed with antenna and radio infrastructures, including MIMO and millimeter wave antennas. Furthermore, in accordance with the present disclosure, a base station (e.g., cell sites 121-123 and/or baseband units within BBU pool 126) may comprise all or a portion of a computing system, such as computing system 300 as depicted in FIG. 3, and may be configured to perform steps, functions, and/or operations in connection with examples of the present disclosure for optimizing the use of unmanned aerial vehicles to extend wireless network coverage.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 6G network components, 5G network components, 3G network components, etc. Thus, cellular core network 130 may comprise an integrated network, e.g., including any two or more of 2G-5G infrastructures and technologies (or any future infrastructures and technologies to be deployed, e.g., 6G and beyond), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and/or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

In one example, a subscriber such as a private enterprise, an emergency response provider, or a military enterprise may utilize one or more unmanned aerial vehicles (UAVs) 104 or 106 to extend a coverage area of a cell site. For instance, in the example illustrated in FIG. 1, a first UAV 104 may be deployed as a base station and a second UAV 106 may be deployed as a relay to privately extend the coverage of the cell site 121. “Privately extend” may encompass the extension of the coverage solely for members of the private enterprise. In other words, for example the private enterprise is permitted by the cellular service provider to extend the cellular coverage of a private network to serve only members or users of the private network.

In one example, the first UAV 104 may include components such as a software defined radio (SDR) that performs signal processing operations (e.g., modulation, demodulation, and the like), a processing system that performs computational operations, an open source 4G and/or 5G radio system, and a rechargeable power supply. The radio system may include one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

Thus, the first UAV 104 combines the functionalities of a stationary base station (e.g., providing a last-hop wireless communication link to mobile subscriber devices) and a mobile drone. In a further example, the second UAV 106 may be configured in a similar manner to the first UAV 104. The ability of the first UAV 104 and the second UAV 106 to change and control their locations may allow the first UAV 104 and the second UAV 106 to dynamically extend the coverage area of the stationary cell site 121 in response to changing demands (e.g., local increases and/or decreases in network traffic).

The first UAV 104 and the second UAV 106 may be in direct communication with the cell site 121. The first UAV 104 and the second UAV 106 may be in direct communication with a service management and organization (SMO) platform 108 that is located at a premises of the subscriber. Collectively, the SMO 108, the first UAV 104, and the second UAV 106 may establish a private network within the access network 120 for the subscriber. As discussed in further detail below, the SMO 108 may receive commands related to the operations of the first UAV 104 and/or the second UAV 106 from the subscriber, where the commands may be phrased in a natural language (e.g., “conserve battery on relay”). The commands may be received, via an external API, from a user endpoint device 110 that is operated by the subscriber such as a cellular telephone, a smartphone, a tablet computing device, a laptop computer, a desktop computer, a pair of computing glasses, a wireless enabled wristwatch, a virtual assistant device, or the like.

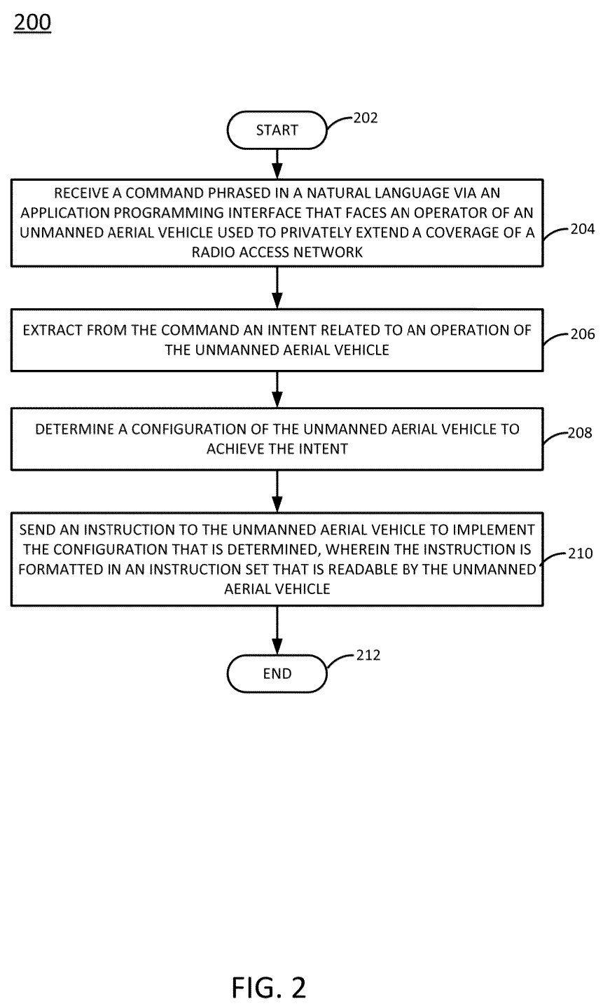

The SMO 108 may translate the natural language commands into instructions that are understandable by the first UAV 104 and/or the second UAV 106. For instance, in one example, the SMO 108 may translate the natural language commands into instructions in the open fronthaul (O-FH) instruction set (e.g., “relay-array-carrier_1: Inactive”). This will allow the subscriber to securely manage operation of the first UAV 104 and the second UAV 106, even if the subscriber lacks specialized expertise in UAV configuration. FIG. 2 illustrates one example of a method 200 that may be performed by a processing system of the SMO 108 to optimize the use of unmanned aerial vehicles to extend wireless network coverage.

In one example, the SMO 108 may comprise all or a portion of a computing system, such as computing system 300 depicted in FIG. 3, and may be configured to perform steps, functions, and/or operations in connection with examples of the present disclosure for optimizing the use of unmanned aerial vehicles to extend wireless network coverage. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the cellular core network 130 may further include an application server (AS) 195, which may comprise a computing system or server, such as computing system 300 depicted in FIG. 3, and may be configured to provide one or more operations or functions in connection with examples of the present disclosure for optimizing the use of unmanned aerial vehicles to extend wireless network coverage. The cellular core network 130 may also include a database (DB) 197 that is communicatively coupled to the AS 195.

The AS 195 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the AS 195 may be configured to optimize the use of unmanned aerial vehicles to extend wireless network coverage, and the like. For instance, in some examples, the AS 195 may communicate with the SMO 108 and/or the first UAV 104 and second UAV 106 to optimize operations of the first UAV 104 and the second UAV 106. To this end, the AS 105 may perform any of the operations performed by the SMO 108 or may support the SMO 108 in performing the operations described above.

In one example, the DB 197 may operate as a repository for information about UAVs deployed in the access network 120, such as the first UAV 104 and the second UAV 106. For instance, the DB 197 may store information such as the IP address, media access control (MAC) address, current location, location history, current battery life, current antenna configuration, and other information about the first UAV 104 and the second UAV 106. In one example, the DB 197 may comprise a physical storage device integrated with the AS 195 (e.g., a database server or a file server), or attached or coupled to the AS 195, in accordance with the present disclosure. In one example, the AS 195 may load instructions into a memory, or one or more distributed memory units, and execute the instructions for optimizing the use of unmanned aerial vehicles to extend wireless network coverage, as described herein.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for optimizing the use of unmanned aerial vehicles to extend wireless network coverage, in accordance with the present disclosure. In one example, the method 200 may be performed by a service management and organization platform that is configured to optimize the use of unmanned aerial vehicles to extend wireless network coverage, such as the SMO 108 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may receive a command phrased in a natural language via an application programming interface that faces (broadly interacts with) an operator of an unmanned aerial vehicle used to privately extend a coverage of a radio access network.

In one example, the RAN may comprise a private O-RAN, and the operator of the UAV may be a private enterprise (e.g., a business entity), a military organization, or the like. In one example, the coverage of the O-RAN may be extended using at least a first UAV as a base station of the O-RAN and a second UAV as a relay. The second UAV amplifies radio frequency signals emitted by the first UAV, so that a physical coverage area of the O-RAN is extended beyond the physical area in which the radio frequency signals emitted by the first UAV would reach without amplification.

In one example, the processing system may be located on a premises of the operator (e.g., within a building that is owned or leased by the operator). For instance, in one example, the processing system may comprise a component of a service management and organization (SMO) platform that is deployed at the premises of the operator. Private deployment of the SMO platform at the premises of the operator may allow the operator to leverage the advantages of UAV deployment within an open network while providing the operator with a measure of privacy and security by minimizing exposure of the operator's operations to third parties via the open network.

The SMO may run an application that executes the method 200 and may include the API to receive natural language commands from the operator. In one example, the API may be an external API that is part of a gateway function of the SMO that performs operations including authentication, access control, and load balancing.

In one example, the command may be received in any one of a plurality of possible modalities. For instance, the command may comprise an audio (e.g., spoken) command, a text (e.g., typed) command, a visual or image (e.g., gesture) command, or another form of command. As discussed above, the command is phrased in a natural language, i.e., in a manner that is consistent with typical human speech and patterns, as opposed to a machine or computer readable language (e.g., a programming language). For instance, the command may comprise a statement such as “conserve battery on the relay (UAV)” or “optimize the beam configuration of the base station (UAV).”

In step 206, the processing system may extract from the command an intent related to an operation of the unmanned aerial vehicle. In one example, the processing system may utilize one or more speech processing and/or natural language processing (NLP) techniques (e.g., NPL techniques from Aylien™, Google™ Cloud Natural Language API, Amazon™ Comprehend, and the like) in order to extract the intent. For instance, if the command is a spoken command, the processing system may need to first transcribe the spoken command into a text string. Subsequently, the processing system may extract the intent from the text string. In other words, the processing system may use an NLP technique in order to parse a meaning from the text string, where the meaning may be some result that the command is trying to achieve in the RAN. As an example, if the command is “conserve battery on the relay,” the intent extracted from the command may generally indicate that operation of a relay UAV should be adjusted to minimize unnecessary consumption of the relay UAV's battery (e.g., by turning the relay UAV off during times in which the volume of network traffic handled by the relay UAV is below a threshold volume). If the command is “optimize the beam configuration of the base station,” the intent extracted from the command may generally indicate that an antenna configuration (e.g., direction and/or angle of emission, signal strength, etc.) should be adjusted to increase the signal strength of the RF signals emitted by the base station in a physical location where network traffic volume is greatest or to minimize interference with RF signals emitted by another base station.

In step 208, the processing system may determine a configuration of the unmanned aerial vehicle to achieve the intent. In one example, the processing system may have knowledge of a current configuration of the UAV. For instance, the processing system may have stored information regarding the most recent instruction that was sent by the processing system to the UAV to instruct the UAV to adjust its configuration. In another example, the processing system may poll the UAV for its current configuration.

In one example, the configuration of the UAV that is likely to achieve the intent may be based at least in part, on current network traffic conditions within the RAN. For instance, changes to the configuration of the UAV may be limited by the current volumes of network traffic, current network link throughput or bandwidth, current latency of network links, and the like. In one example, metrics describing current network traffic conditions may be reported to the processing system by one or more network probes. In another example, the processing system may collect data regarding packet handling (e.g., round trip time or the like) and may calculate the metrics based on the collected data.

Once the processing system understands the result that the command is trying to achieve (e.g., via extraction of intent in step 206), and knowing the current configuration of the UAV and current network traffic conditions, the processing system may determine whether the current configuration of the UAV can achieve the result, or whether the configuration of the UAV must be modified to achieve the result. For instance, if the intent is to minimize unnecessary consumption of battery on a relay UAV, and the volume of network traffic that is currently being handled by the relay UAV is below a threshold, then the configuration that is likely to achieve the intent may be to power off the relay UAV (e.g., so that the volume of network traffic that is currently being handled by the relay UAV is rerouted over one or more different paths not including the relay UAV). If the intent is to optimize the beam configuration of a base station UAV, then the configuration that is likely to achieve the intent may include an adjustment to the direction of a beam formed by the antennas of the base station UAV to improve RF signal strength in a specific physical location of the RAN that is experiencing high volumes of network traffic. In other examples, the configuration may involve a change to a physical location of UAV (e.g., to increase or decrease the signal strength of RF signals in a specific physical location).

In step 210, the processing system may send an instruction to the unmanned aerial vehicle to implement the configuration that is determined, wherein the instruction is formatted in an instruction set that is readable by the unmanned aerial vehicle.

The UAV may be unable to understand commands phrased in natural language, or to translate such commands into specific actions or configurations. However, once the processing system has determined a configuration or an action to be made to the current configuration in step 208, the processing system may translate that configuration to an instruction that can be understood and acted upon by the UAV.

In one example, the instruction may be formatted in the open fronthaul (O-FH) specification, which is a defined set of instructions for UAVs to follow. The O-FH specification is substantially universal, meaning that any UAV that subscribes to the O-FH specification, regardless of the manufacturer, make, or model of the UAV, will be able to understand and act on instructions provided in the O-FH specification. The processing system may send the instruction via an O-FH M-plane interface of the SMO platform. As an example, a command phrased in natural language as “conserve battery on relay” may be translated into an O-FH-M command of “relay-array-carrier_1: Inactive” to a specific relay UAV.

The method 200 may end in step 212.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a service management and organization platform (such as might be used to perform the method 200) could be implemented as illustrated in FIG. 3.

As depicted in FIG. 3, the system 300 comprises a hardware processor element 302, a memory 304, a module 305 optimizing the use of unmanned aerial vehicles to extend wireless network coverage, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for optimizing the use of unmanned aerial vehicles to extend wireless network coverage may include circuitry and/or logic for translating commands received in a natural language into machine readable instructions that can be carried out by an unmanned aerial vehicle. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for optimizing the use of unmanned aerial vehicles to extend wireless network coverage (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for optimizing the use of unmanned aerial vehicles to extend wireless network coverage (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system including at least one processor, a command phrased in a natural language via an application programming interface that interacts with an operator of an unmanned aerial vehicle used to extend a coverage of a radio access network;
extracting, by the processing system from the command, an intent related to an operation of the unmanned aerial vehicle;
determining, by the processing system, a configuration of the unmanned aerial vehicle to achieve the intent; and
sending, by the processing system, an instruction to the unmanned aerial vehicle to implement the configuration that is determined, wherein the instruction is formatted in an instruction set that is readable by the unmanned aerial vehicle.

2. The method of claim 1, wherein the radio access network is a fifth generation open radio access network.

3. The method of claim 1, wherein the unmanned aerial vehicle is deployed as a mobile base station of the radio access network.

4. The method of claim 1, wherein the unmanned aerial vehicle is deployed as a relay to amplify radio frequency signals emitted by a base station of the radio access network.

5. The method of claim 1, wherein the processing system is part of a service management and organization platform that is physically located at a premises of the operator of the unmanned aerial vehicle.

6. The method of claim 5, wherein the application programming interface is part of a gateway function of the service management and organization platform that is responsible for at least one of: an authentication process, an access control process, or a load balancing process.

7. The method of claim 1, wherein the command relates to a conservation of a battery of the unmanned aerial vehicle.

8. The method of claim 7, wherein the configuration comprises a powering off of the unmanned aerial vehicle when a volume of network traffic is below a threshold.

9. The method of claim 1, wherein the command relates to an antenna configuration of the unmanned aerial vehicle.

10. The method of claim 9, wherein the configuration comprises an adjustment to the antenna configuration to direct a beam formed by the antenna configuration to increase a radio frequency signal strength in a physical location where a volume of network traffic is above a threshold.

11. The method of claim 9, wherein the configuration comprises an adjustment to the antenna configuration to direct a beam formed by the antenna configuration to minimize interference of radio signals emitted by the unmanned aerial vehicle with radio signals emitted by a fixed location base station of the radio access network.

12. The method of claim 1, wherein the configuration comprises a change to a physical location of the unmanned aerial vehicle.

13. The method of claim 1, wherein the instruction set is an open fronthaul specification instruction set.

14. The method of claim 13, wherein the unmanned aerial vehicle subscribes to the open fronthaul specification instruction set.

15. The method of claim 13, wherein the instruction is sent via an open fronthaul M-place interface of the processing system.

16. The method of claim 1, wherein the radio access network comprises a fifth generation open radio access network, and the processing system and the unmanned aerial vehicle collectively establish a private network within the fifth generation open radio access network for the operator of the unmanned aerial vehicle.

17. The method of claim 1, wherein the unmanned aerial vehicle is one of a plurality of unmanned aerial vehicles deployed by an enterprise to extend the coverage of the radio access network.

18. The method of claim 1, wherein the unmanned aerial vehicle includes a directional antenna.

19. A non-transitory computer-readable medium storing instructions which, when executed by a processing system including at least one processor, cause the processing system to perform operations, the operations comprising:
receiving a command phrased in a natural language via an application programming interface that interacts with an operator of an unmanned aerial vehicle used to extend a coverage of a radio access network;
extracting, from the command, an intent related to an operation of the unmanned aerial vehicle;
determining a configuration of the unmanned aerial vehicle to achieve the intent; and
sending an instruction to the unmanned aerial vehicle to implement the configuration that is determined, wherein the instruction is formatted in an instruction set that is readable by the unmanned aerial vehicle.

20. A device comprising:
a processing system including at least one processor; and
a computer-readable medium storing instructions which, when executed by the processing system, cause the processing system to perform operations, the operations comprising:
receiving a command phrased in a natural language via an application programming interface that interacts with an operator of an unmanned aerial vehicle used to extend a coverage of a radio access network;
extracting, from the command, an intent related to an operation of the unmanned aerial vehicle;
determining a configuration of the unmanned aerial vehicle to achieve the intent; and
sending an instruction to the unmanned aerial vehicle to implement the configuration that is determined, wherein the instruction is formatted in an instruction set that is readable by the unmanned aerial vehicle.
